(19) United States
(12) Patent Application Publication
(10) Pub. No.: US 2010/0102659 A1
(43) Pub. Date: Apr. 29, 2010

(54) Motor for driving color wheel

(75) Inventors: Yuzuru Suzuki, Kitasaku-gun (JP); Yuuki Takahashi, Kitasaku-gun (JP); Tomoyuki Suzuki, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., Kitasaku-gun (JP)

(21) Appl. No.: 12/588,207

(22) Filed: Oct. 7, 2009

(30) Foreign Application Priority Data
Oct. 24, 2008 (JP) 2008-274318

(51) Int. Cl. H02K 11/00

(52) U.S. Cl. 310/71; 310/68 B

(57) ABSTRACT

A motor for driving a color wheel includes: a main body including a rotor with a shaft, a housing having a cylindrical shape, and a front plate disposed at one axial end of the main body, from which one end portion of the shaft protrudes; a color wheel attachment structure fitted around the protruding end portion of the shaft; at least one position signal generating means disposed at a surface of the color wheel attachment structure facing the front plate; a relay board extending radially outwardly from inside the main body so as to protrude from the circumferential wall of the housing and functioning to guide out lead wires of windings of the motor; and a rotational position detecting means disposed at a portion of the relay board located inside the main body, and facing the position signal generating means thereby receiving a signal from the position signal generating means.

### BACKGROUND OF THE INVENTION

1. Field of the Invention

The present invention relates to a motor for driving a color wheel, which is used in optical devices such as a projector, and display devices such as a rear-projection television.

2. Description of the Related Art

In recent years, a large screen display, for example, for a home theater or a presentation, has suddenly started attracting a lot of attention, and an LCD (liquid crystal display) projector or a DMD (digital micro-mirror device) is now commercially available in which an image displayed on a small LCD panel or a DMD is enlarged and projected by a projection lens thereby producing a large image on a screen. Such a projector may be mostly a color display device using a single panel projector, specifically a color display device of time shared color sequential system in which color mixing by time sharing is utilized.

In the single panel projector, light emitted from a light source, when passing through an RGB color wheel (glass disk), is extracted sequentially according to an frequency band of R, G or B and irradiated onto a DMD. Then, the reflection light from the DMD is guided to a screen, whereby a colored image is produced and displayed thereon. In such a device, a DC brushless motor is generally employed for driving a color wheel.

The motor for driving a color wheel (hereinafter referred to as “color wheel motor” or simply “motor” as appropriate) is an outer rotor brushless DC motor including: a stator which includes a stator yoke made of a plurality of punched silicon steel plates stacked on one another and disposed on the outer circumference of a hollow bearing housing to hold bearings therein, and a coil made of a magnet wire wound around the stator yoke; and a rotor which includes a rotor magnet disposed so as to oppose the outer circumferential surface of the stator yoke, and a rotary shaft inserted through the center of the rotor magnet and rotatably supported by the bearings; and a plate-like structure adapted to attach a color wheel, made of a magnetic material and disposed on one axial end of the rotor magnet.

Since the motor is to drive and control the color wheel which includes a plurality of color segments and which is attached at the rotor, a reference position of the color wheel must be detected. To this end, a light reflective sticker for rotational position detection is attached on the outer circumferential surface of the rotor and an optical sensor is disposed externally of the motor, whereby the rotational position of the color wheel is duly detected.

Specifically, referring to FIG. 4 showing a conventional color wheel motor, a light reflective sticker 36 having a high light reflectance is attached on an outer circumferential surface 34 of a rotor of an outer rotor brushless motor 32 for rotating a color wheel 30, and the passage of the light reflective sticker 36 is detected by an optical sensor 40 which is provided on a relay board 38 externally provided.

Since, as shown in FIG. 4, the light reflective sticker 36 for rotational position detection is disposed at the outer circumferential surface 34 of the rotor and the optical sensor 40 is disposed outside the motor in order to detect the rotational position of the color wheel 30, an additional space is required for mounting the optical sensor 40. Also, the optical sensor 40 is disposed separately from the motor and therefore the position of the optical sensor 40 relative to the motor must be adjusted, which makes the assembly work complicated.

FIG. 5 shows a structure of another conventional color wheel motor, in which a position marker 44 is disposed on the inner surface (lower side in the figure) of a retainer ring 42 to fixedly hold a color wheel 30, and the rotational position of the color wheel 30 is detected by a position detector 50 disposed on a motor support member 46 (refer to, for example, Japanese Patent Application Laid-Open No. H10-48542).

In the structure described above, the color wheel (color filter segments) 30 fixedly attached between a color wheel support member 48 and the retainer ring 42 is rotated by a rotor 35 disposed inside a motor 45. The position marker 44 is disposed on the inner surface of the retainer ring 42 as described above, and the position detector 50 is disposed at a portion of the motor support member 46 located radially outside the outer diameter of a housing of the motor 45.

Since the position detector 50, while disposed on the motor support member 46, is located radially outside the outer diameter of the motor 45, the position marker 44 is also located radially outside the diameter of the motor 45. Therefore, the color wheel 30 must have a light beam receiving portion located radially outside the motor support member 46, wherein the position detector 50 and the position marker 44 are disposed on the motor support member 46 and the color wheel support member 48, respectively, so as to be located radially outside the diameter of the motor 45, thus hindering downsizing of the structure.

Since the position detector 50 is disposed outside the motor 45, the wiring in the motor 45 and the wiring of the position detector 50 are separated from each other, which results in hindering downsizing of the structure. Also, since the position marker 44 and the position detector 50, which are disposed at the color wheel 30 and the motor support member 46, respectively, must be positioned appropriately with respect to each other, the assembly work is complicated.

Still another conventional color wheel motor is disclosed in Japanese Patent Application Laid-Open No. 2001-337390 and shown in FIG. 6. Referring to FIG. 6, a color wheel motor 56 includes a rotor section 54 to rotate a disk-shaped color filter (color wheel) 52 sectioned into a plurality of color regions, wherein the rotational position of the color wheel 52 can be accurately detected even at a high speed rotation and also at a high temperature.

In FIG. 6, the motor 56 basically includes the rotor section 54 and a bracket section 58, wherein the color wheel 52 is disposed at the rotor section 54 and a Hall IC 60 as magnetic sensor is disposed at the bracket section 58. Detector magnets 62 are disposed at the rotor section 54, and whenever the detector magnets 62 pass by the Hall IC 60, a pulse signal is generated due to the magnetoelectric conversion characteristics of the Hall IC 60.

With the structure described above, a pulse signal for detecting the rotational position of the color wheel 52 can be generated without any additional members to the color wheel 52 and the rotor section 54, and the Hall IC (magnetic sensor) 60 can be housed inside a motor. Consequently, the color wheel 52 does not have to have an index mark put thereon, and the signal for detecting the rotational position can be generated stably even at a high rotation and also at a high temperature.

The motor 56, however, requires such troublesome works as inserting a common pin through positioning holes of the color wheel 52 and the motor 56, engaging positioning keys with key grooves, or like work, in order to properly position the color wheel 52 relative to the motor 56.

Further, the Hall IC 60 as the magnetic sensor is disposed on the inner circumferential surface of the bracket section 58 and the detector magnets 62 are disposed on the outer circumferential surface of the rotor section 54, wherein an air gap is provided radially between the Hall IC 60 and the detector magnets 62, consequently the motor 56 cannot be downsized.

For small mobile projectors for which a market is expected to expand in the future, it is requested that a color wheel motor with a small diameter and a low profile be urgently designed and developed. In the conventional color wheel motor shown in FIG. 4, since the rotational position of the color wheel is detected by the detector disposed outside the motor, a space for the detector is additionally required.

In FIG. 4, since the rotational position detector is the optical sensor provided separately from the main body of the motor, the number of components is increased thus increasing component cost as well as taking time and effort to attach and align the rotational position detector.

Also, in the conventional color wheel motor shown in FIG. 5, the rotational position detector is disposed at the motor support member and the position marker is disposed at the retainer ring, wherein since the rotational position detector and the position marker are both located radially outside the outer diameter of the main body of the motor, the color wheel motor is prevented from being reduced in size.

Furthermore, in the color wheel motor shown in FIG. 6, the detecting means can be disposed inside the main body of the motor, but in order to align the color wheel to the motor, jigs such as a pin must be provided, the key and the key groove must be formed, and also the alignment work is required. In addition, it is difficult to downsize the main body because the detecting means is disposed inside the main body.

### SUMMARY OF THE INVENTION

The present invention has been made in light of the circumstances described above, and it is an object of the present invention to provide a motor for driving a color wheel, in which a position signal generating means and a rotational position detecting means are disposed at a color wheel attachment structure and a main body, respectively, so as to face each other and are both located radially inside the diameter of the motor, wherein the rotational position detecting means is mounted on a relay board adapted to accommodate lead-out wires for motor windings, whereby the product precision can be stabilized and the assembly processes can be reduced while downsizing can be successfully achieved.

In order to achieve the object of the present invention, according to an aspect of the present invention, there is provided a motor for driving a color wheel, which includes: _{a ma}in body which includes a rotor provided with a shaft, a housing having a cylindrical shape, and a front plate disposed at one axial end of the main body from, wherein one end portion of the shaft protrudes from the one axial end of the main body; a color wheel attachment structure which has substantially a disk shape, is fitted around the protruding end portion of the shaft, and which rotates together with the color wheel; at least one position signal generating means which is disposed at a surface of the color wheel attachment structure facing the front plate; a relay board which extends radially outwardly from inside the main body so as to protrude from the circumferential wall of the housing, and which guides out lead wires of windings of the motor; and a rotational position detecting means which is disposed at a portion of the relay board located inside the main body, and which faces the position signal generating means thereby receiving a signal from the position signal generating means.

Accordingly, since the position signal generating means is disposed at the color wheel attachment structure to rotate with the color wheel, and the rotational position detecting means to receive a signal from the position signal generating means is disposed inside the motor, an extra space located radially outside the motor dimension and adapted to accommodate the rotational position detecting means is not required, and also the color wheel is properly positioned relative to the motor when the motor assembly is completed.

As a result, the position signal for the color wheel is reliably assured in the motor and at the same time the troublesome work of attaching the rotational position detecting means and adjusting the position thereof can be eliminated. Further, since the rotational position detecting means is located on the relay board for leading out the wiring of the windings of the motor, the connection terminals of both the winding wiring and the rotational position detecting means can be disposed on one single board, and the component assembly work for producing a projector can be simplified, whereby the product precision of the motor can be stabilized, the assembly processes can be reduced, and the motor can be downsized.

In the aspect of the present invention, the position signal generating means and the rotational position detecting means may be either a magnet and a magnetic detector, respectively, or a photoreactive medium and an optic sensor, respectively. Accordingly, the range of options for the position signal generating means and the rotational position detecting means can be expanded according to the color wheel and the motor.

In the aspect of the present invention, the rotational position detecting means may face the position signal generating means such that the rotational position detecting means is exposed either from the front plate or from the circumferential wall of the housing where the relay board protrudes. Accordingly, it can be better ensured that the rotational position detecting means is attached in an affirmative manner and the signal from the position signal generating means is accurately detected.

In the aspect of the present invention, the motor may include two position signal generating means disposed mutually symmetric with respect to the rotation axis of the color wheel attachment structure, and also the position signal generating means may be a plastic magnet and include a positioning boss formed at a surface thereof making contact with the color wheel attachment structure. Accordingly, the signal from the position signal generating means can be detected twice per rotation of the color wheel, and also the position signal generating means made of a plastic magnet can be easily fabricated while it can reliably be fixed to and properly positioned relative to the color wheel attachment structure.

In the aspect of the present invention, the position signal generating means may be disposed so as not to protrude above the surface of the color wheel attachment structure facing the front plate. Accordingly, the color wheel attachment structure can be closer to the front plate of the main body and the outer circumference of the color wheel attachment structure can be aligned to the outer circumference of the housing, whereby the motor can be reduced in diameter and thickness. Also, the wind noises generated at the rotation can be reduced and also the light passing through the color wheel is prevented from being blocked.

In the aspect of the present invention, the color wheel attachment structure may include a recess for accommodating the position signal generating means, and one of a pit and a through-hole for engaging with the positioning boss of the position signal generating means. Accordingly, the position signal generating means can reliably be attached to and properly positioned relative to the color wheel attachment.

In the aspect of the present invention, the output of the rotational position detecting means may go outside the main body by way of the relay board. Accordingly, the output terminals of the rotational position detecting means can be formed at the relay board, the wiring can be simplified and also the wiring component can be eliminated.

In the aspect of the present invention, the front plate may be disposed between the color wheel attachment structure and the rotational position detecting means and be made of a non-magnetic material. Accordingly, there is no affect on the signal sent from the position signal generating means to the rotational position detecting means.

In the aspect of the present invention, the front plate may allow the rotational position detecting means to be exposed. Accordingly, the signal can be reliably detected.

According to the present invention, since the rotational position detecting means is disposed inside the main body, the position signal for the color wheel can be reliably detected. Also, in the projector assembly work, the adjustment work is not required after the motor is assembled, the position signal of the color wheel can be detected with an increased accuracy and the assembly and adjustment processes are reduced while the motor is downsized.

### BRIEF DESCRIPTION OF THE DRAWINGS

FIG. 1 is a perspective view of a motor for driving a color wheel according to an embodiment of the present invention, wherein a color wheel is not attached;

FIG. 2A is an axial cross sectional view of the motor of FIG. 1, wherein a color wheel is attached, and FIG. 2B is an enlarged view of a portion of FIG. 2A;

FIG. 3 is a top plan view of a relay board of the motor of FIG. 1, showing a wiring arrangement;

FIG. 4 is a perspective view of a conventional motor for a driving a color wheel, showing a light reflective sticker for rotational position detection purpose;

FIG. 5 is a partly cross sectional view of another conventional motor for driving a color wheel, wherein a color wheel is attached; and

FIG. 6 is a cross sectional view of still another conventional motor for driving a color wheel, wherein a color wheel is attached.

### DETAILED DESCRIPTION OF THE INVENTION

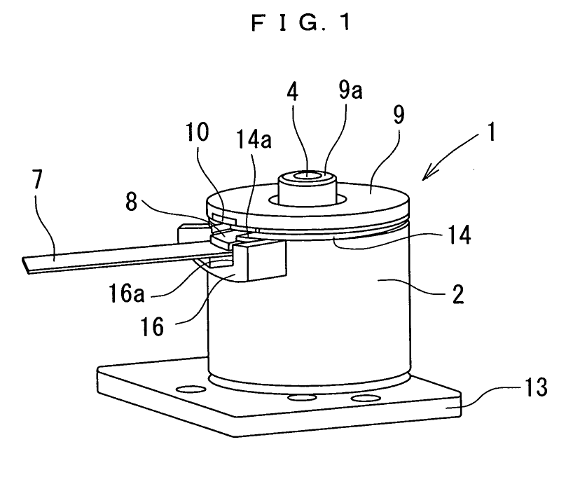

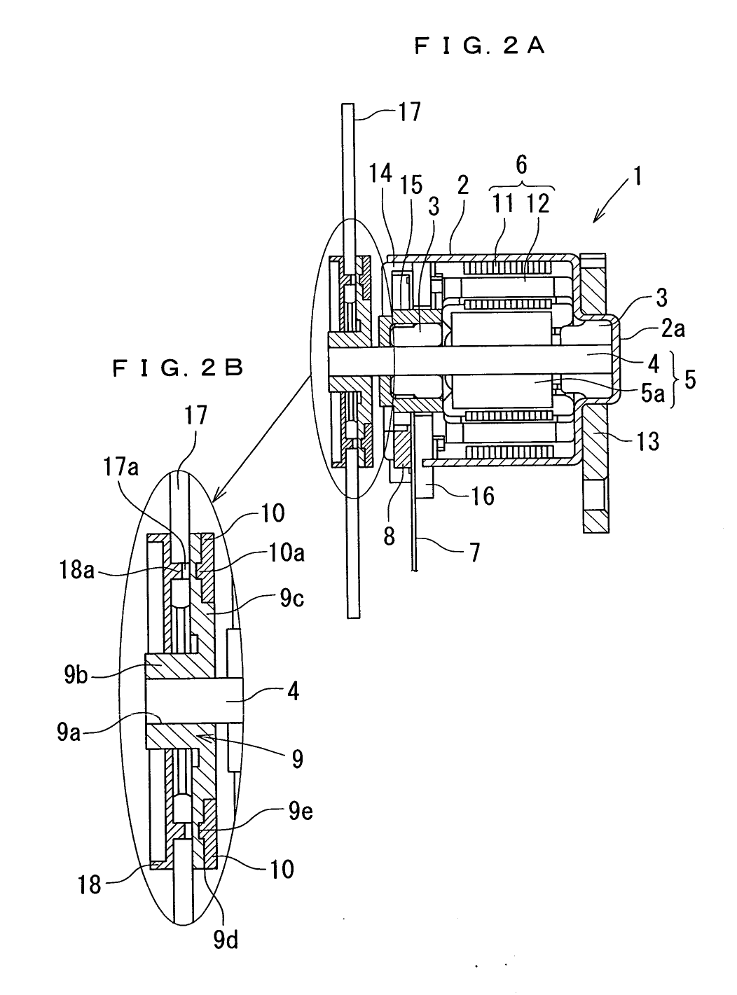

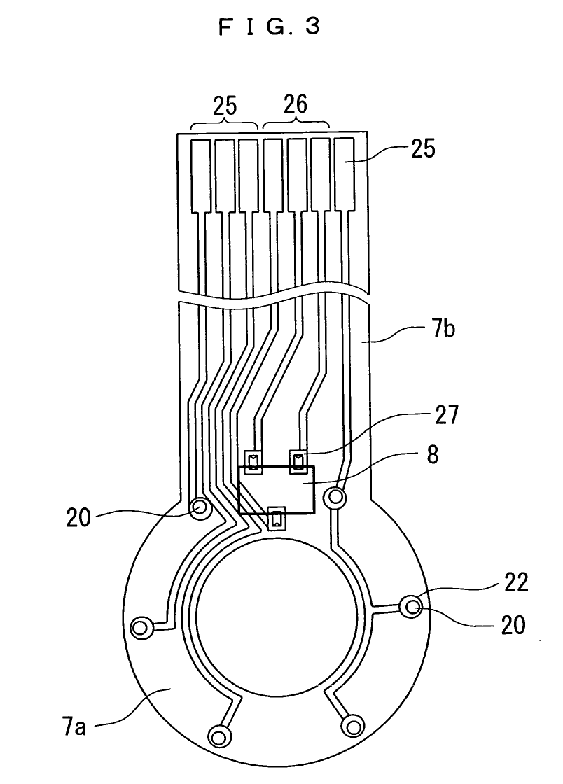

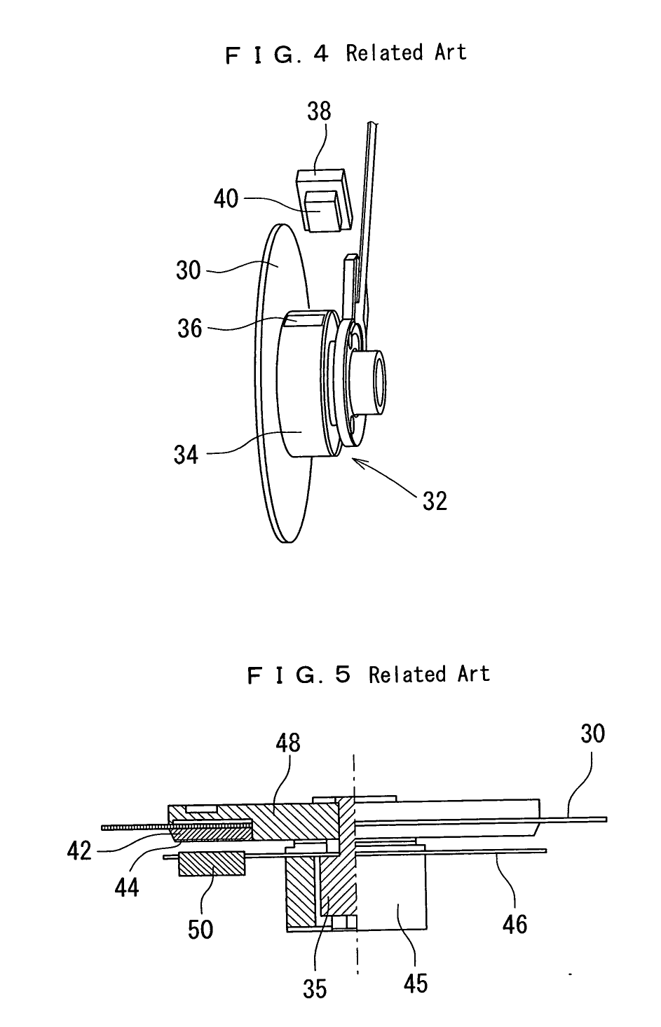

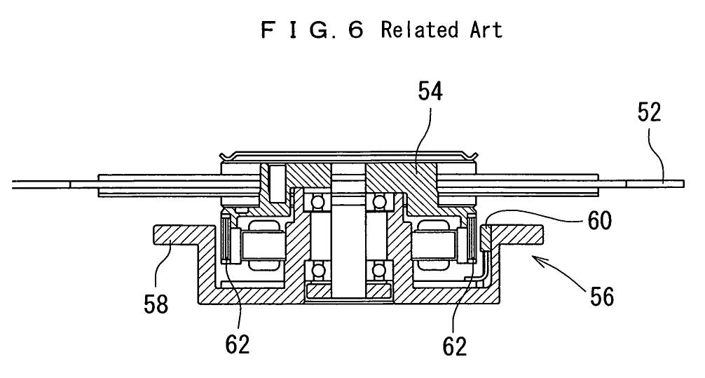

An exemplary embodiment of the present invention will hereinafter be described with reference to the accompanying drawings. FIG. 1 perspectively shows a motor 1 for driving a color wheel according to one embodiment of the present invention, FIG. 2A shows a cross section of the motor 1 with a color wheel attached, FIG. 2B shows an enlargement of a portion of FIG. 2A, and FIG. 3 shows a relay scheme of the motor 1.

As shown in FIGS. 1, 2A and 2B, the motor 1 according to the present embodiment basically includes a main body and a color wheel attachment structure 9. The main body includes: a housing 2 having a circular cylindrical shape and serving as a main body case; a rotor 5 including a shaft 4 which has one end portion protruding from one axial end of the main body and which is rotatably supported by bearings 3, 3 disposed inside the housing 2; a stator 6 fixedly attached to the housing 2 and opposing the rotor 5; and a relay board 7 extending radially outwardly from inside the main body, wherein a magnetic detector (constituted by a Hall IC) 8 functioning as rotational position detecting means is disposed at the relay board 7. On the other hand, the color wheel attachment structure 9 for attaching a color wheel has a disk shape, wherein two magnets 10 functioning as position signal generating means are disposed.

Referring to FIG. 1, the motor 1 further includes a relay board hold member 16 which has an opening 16a and which is disposed to protrude from the outer circumferential surface of the housing 2, wherein the relay board 7, which extends from inside the main body, is supported by the relay board hold member 16, further extends radially outwardly through the opening 16a and protrudes from the housing 2.

The magnetic detector 8 is disposed on the relay board 7 and exposed through the opening 16a. The color wheel attachment structure 9 is attached to the protruding end portion of the shaft 4 of the rotor 5, and the magnets 10 are disposed on a surface (inner surface) of the color wheel attachment structure 9 facing the main body, such that two of the magnets 10 are mutually symmetric with respect to the rotation axis. The magnets 10 are each adapted to axially face the magnetic detector 8 disposed on the relay board 7 through a cutout 14a of a front plate 14 of the main body. A fixing plate 13 and a color wheel 17 are attached at one axial end (rear end) and the other axial end (front end), respectively, of the motor 1 as shown in FIG. 2A.

Referring to FIG. 2A, the stator 6 includes: a stator yoke 11 which is composed of a plurality of punched silicon steel plates axially stacked on one another and which is ring-shaped with a plurality of salient poles formed at its inner circumference; and a plurality of windings 12 wound around a bobbin which is made of polymer material and which is attached on the stator yoke 11, while the rotor 5 includes a rotor magnet 5a which is multipole magnetized at its outer circumference and which is disposed around the shaft 4 so as to have a minute air gap from the salient poles of the stator yoke 11.

One of the bearings 3, 3 is disposed at a recess 2a formed at one axial end (toward the main body rear end) of the housing 2 engaged with the outer circumference of the stator yoke 11, and the other bearing 3 is disposed at a bearing holder 15 fixed to the front plate 14 attached to the other axial end (toward the main body front end) of the housing 2, wherein the shaft 4 is rotatably supported by the bearings 3, 3.

The relay board hold member 16, on which the relay board 7 is disposed, is fixed to the bearing holder 15 and has a distal end radially protruding beyond the housing 2 to thereby support the relay board 7 having an elongated shape. For this reason, the opening 16a through which the relay board 7 disposed on the relay board hold member 16 is allowed to protrude is formed at the circumferential wall of the housing 2.

Also, the magnetic detector 8 is disposed to face each of the magnets 10 which are disposed at the color wheel attachment structure 9 and which generate position signal. The magnetic detector 8 is constituted by, for example, a Hall IC that receives the magnetic signal sent from the magnets 10, 10.

The magnetic detector 8 is attached to the relay board 7 and located to the outer diameter of the color wheel attachment structure 9, preferably such that the radially outer end of the magnetic detector 8 is aligned to the outer diameter of the housing 2. Consequently, the radially outer end of the magnetic detector 8 protrudes slightly beyond the outer diameter of the front plate 14, and the protruding portion of the magnetic detector 8 is adapted to axially face each of the magnets 10 disposed at the color wheel attachment structure 9.

In the motor 1 according to the present embodiment, the color wheel 17 is fixedly attached between the color wheel attachment structure 9 and a color wheel locking plate 18 as shown in FIG. 2B. The color wheel attachment structure 9 includes an axis portion 9b having a center hole 9a through which the protruding end portion of the shaft 4 of the rotor 5 is inserted, and a flange portion 9c having an outer diametral dimension corresponding to the outer diametral dimension of the housing 2. The color wheel locking plate 18 includes a center hole, and a plurality of engagement bosses 18a formed at a surface thereof making contact with the color wheel 17.

The color wheel 17 is attached and fixed as follows. The engaging bosses 18a of the color wheel locking plate 18 are inserted into respective throughholes 17a of the color wheel 17 and adhesively fixed thereto thereby forming a combined unit, and the combined unit is attached to the color wheel attachment structure 9 such that the center hole of the color wheel locking plate 18 is fitted over and adhesively fixed to the axis portion 9b of the color wheel attachment structure 9 which is engaged onto the protruding end portion of the shaft 4 of the rotor 5.

The color wheel attachment structure 9 further includes, at its inner surface, recesses 9d in each of which each of the magnets 10 is accommodated and each of which is provided with a pit 9e (or throughhole) for positioning the magnet 10.

The magnets 10, which are constituted by a plastic magnet easily formed by molding, are each embedded in the recess 9c such that a positioning boss 10a formed on the contact surface of the magnet 10 is engaged in the pit 9e at the recess 9c and is adhesively fixed. While at least one magnet as position signal generating means is to be provided in the motor, it is preferable that, as in the embodiment described above, two of the magnets 10 are provided to be mutually symmetric with respect to the rotation axis on the color wheel attachment structure 9, wherein the open surface of the magnet 10 is set flush with (or not protruding above) the inner surface of the color wheel attachment structure 9 to thereby reduce wind noise.

Thus, the magnets 10 are each fixedly mounted with its one surface exposed to face toward the main body and set flush with the inner surface of the color wheel attachment structure 9. And, the magnetic detector 8 is disposed to face each of the magnets 10 and therefore is to be situated at a portion of the relay board 7 located radially inside the main body.

The relay board 7 of the motor 1 according to the present embodiment is disposed on the relay board hold member 16 and adapted to allow the lead terminals of the windings 12 to go out of the main body. The relay board 7 shown in FIG. 3 is constituted by a printed circuit board but may alternatively be constituted by a flexible substrate, or the like.

The relay board 7 is composed integrally of a circular portion 7a and a rectangular portion 7b. The circular portion 7a includes a plurality (six in the figure) of winding connection contacts 22 each of which has a hole 20 and to which terminals 25 for excitation of the windings 12 are connected. On the rectangular portion 7b, terminals 26 for the magnetic detector 8 as well as the terminals 25 for the windings 12 are print-wired.

The relay board 7 further includes three connection contacts 27 for accommodation as well as connection for the magnetic detector (rotational position detecting means) 8 at a portion communicating between the circular portion 7a and the rectangular portion 7b. Consequently, according to the embodiment, both the windings 12 and the magnetic detector 8 can achieve electrical connection by means of the contacts 22 and 27 and the terminals 25 and 26 which are all disposed on only one board (the relay board 7). Thus, the relay board 7 alone enables the windings 12 to be supplied with electric power and at the same time the output of the magnetic detector 8 to be taken out. Also, since the wiring of the magnetic detector 8 is not present inside the main body, noises generated inside the main body are prevented from having affects. And, no materials are required for such a wiring and the cost is reduced.

Also, according to the embodiment of the present invention, the rotational position detecting means can be disposed on the relay board 7 and the position signal generating means can be disposed on the color wheel attachment structure 9, wherein the rotational position detecting means is the magnetic detector 8 constituted by, for example, a Hall IC, and the position signal generating means is the magnet 10 adapted to magnetically generate the signal.

The present invention is not limited to the above arrangement, and the rotational position detecting means may be constituted, for example, by an optical sensor while the position signal generating means is constituted by a photoreactive medium. In the motor for driving a color wheel according to the present invention, the sensors mentioned above can be disposed within the outer diameter of the main body, and the resulting motor has a small diameter and a small profile.

What is claimed is:

1. A motor for driving a color wheel, the motor comprising:
a main body comprising a rotor provided with a shaft, a housing having a cylindrical shape, and a front plate disposed at one axial end of the main body, wherein one end portion of the shaft protrudes from the one axial end of the main body;
a color wheel attachment structure having substantially a disk shape, fitted around the protruding end portion of the shaft and adapted to rotate together with the color wheel;
at least one position signal generating means disposed at a surface of the color wheel attachment structure facing the front plate;
a relay board extending radially outwardly from inside the main body so as to protrude from a circumferential wall of housing, the relay board functioning to guide out lead wires of windings of the motor; and
a rotational position detecting means disposed at a portion of the relay board located inside the main body, the rotational position detecting means facing the position signal generating means thereby receiving a signal from the position signal generating means.

2. A motor for driving a color wheel according to claim 1, wherein the position signal generating means and the rotational position detecting means are either a magnet and a magnetic detector, respectively, or a photoreactive medium and an optic sensor, respectively.

3. A motor for driving a color wheel according to claim 1, wherein the rotational position detecting means faces the position signal generating means such that the rotational position detecting means is exposed either from the front plate or from the circumferential wall of the housing where the relay board protrudes.

4. A motor for driving a color wheel according to claim 1, wherein the motor comprises two position signal generating means disposed mutually symmetric with respect to a rotation axis of the color wheel attachment structure.

5. A motor for driving a color wheel according to claim 1, wherein the position signal generating means is a plastic magnet and comprises a positioning boss formed at a surface thereof making contact with the color wheel attachment structure.

6. A motor for driving a color wheel according to claim 1, wherein the position signal generating means is disposed so as not to protrude above the surface of the color wheel attachment structure facing the front plate.

7. A motor for driving a color wheel according to claim 5, wherein the color wheel attachment structure comprises a recess for accommodating the position signal generating means, and one of a pit and a through-hole for engaging with the positioning boss of the position signal generating means.

8. A motor for driving a color wheel according to claim 1, wherein an output of the rotational position detecting means goes outside the main body by way of the relay board.

9. A motor for driving a color wheel according to claim 1, wherein the front plate is disposed between the color wheel attachment structure and the rotational position detecting means and made of a non-magnetic material.
